(19) United States
(12) Patent Application Publication
(10) Pub. No.: US 2005/0110707 A1
(43) Pub. Date: May 26, 2005

(54) Method and apparatus for driving discharge display panel to improve linearity of gray-scale

(76) Inventor: Im-Su Choi, Asan-si (KR)

Correspondence Address: Robert E. Bushnell, Suite 300, 1522 K Street, N.W., Washington, DC, 20005-1202, US

(21) Appl. No.: 10/977,940

(22) Filed: Nov. 1, 2004

(30) Foreign Application Priority Data
Nov. 22, 2003 (KR) 2003-83367

(51) Int. Cl. G09G 3/28

(52) U.S. Cl. 345/60

(57) ABSTRACT

A method of driving a discharge display panel includes steps (a) thru (c) as follows. In step (a), the number of sustaining discharge pulses is set for each sustaining discharge period so as to be proportional to a gray-scale weight assigned to each sub-field and so as to be inversely proportional to an average signal level of each frame. In step (b), when a frame has an average signal level at which ratios between the gray-scale weights of the respective sub-fields are not varied in accordance with the set number of sustaining discharge pulses, the driving is performed in accordance with the set number of sustaining discharge pulses. In step (c), when the frame has an average signal level at which the ratios between the gray-scale weights of the respective sub-fields are varied in accordance with the set number of sustaining discharge pulses, a signal level of image data is adjusted and the driving is performed in accordance with a gain inversely proportional to the average signal level regardless of the set number of sustaining discharge pulses. An apparatus for driving a discharge display panel comprises means for performing functions corresponding to steps (a) thru (c).

### CLAIM OF PRIORITY

This application makes reference to, incorporates the same herein, and claims all benefits accruing under 35 U.S.C. §119 from an application for METHOD OF DRIVING DISCHARGE DISPLAY PANEL FOR IMPROVING LINEARITY OF GRAY-SCALE earlier filed in the Korean Intellectual Property Office on 22 Nov. 2003 and there duly assigned Serial No. 2003-83367.

### BACKGROUND OF THE INVENTION

1. Technical Field

The present invention relates to a method and apparatus for driving a discharge display panel and, more particularly, to a method and apparatus for driving a discharge display panel in which a unit frame is driven in a time division manner with a plurality of sub-fields.

2. Related Art

A three-electrode surface-discharge plasma display panel contains, between a front glass substrate and a rear glass substrate of the surface-discharge plasma display panel, address electrode lines, dielectric layers, Y electrode lines, X electrode lines, fluorescent substances, partitioning walls, and a magnesium monoxide (MgO) layer.

The address electrode lines are formed in a predetermined pattern on the surface of the rear glass substrate. The rear dielectric layer is formed on the whole surface including the address electrode lines. The partitioning walls are formed on the surface of the rear dielectric layer so as to be parallel to the address electrode lines. The partitioning walls define discharge regions of the respective cells, and serve to prevent optical interference (cross talk) between the cells. The fluorescent substances are formed between the partitioning walls.

The X electrode lines and the Y electrode lines are formed in a predetermined pattern on the surface of the front glass substrate so as to be perpendicular to the address electrode lines. The respective intersections define the corresponding cells. Each of the X electrode lines and each of the Y electrode lines are formed as a combination of a transparent electrode line made of a transparent conductive material, such as indium tin oxide (ITO), and a metal electrode line for enhancing electrical conductivity thereof. The front dielectric layer is formed on the whole surface including the X electrode lines and the Y electrode lines. A protective layer, for example, a magnesium monoxide (MgO) layer, for protecting the panel from an intensive electric field is formed on the whole surface of the front dielectric layer. Plasma forming gas is injected into the discharge spaces, and is then sealed up.

An address-display separation driving method for the Y electrode lines is described in U.S. Pat. No. 5,541,618. Each unit frame is divided into eight sub-fields so as to realize a time-divisional gray scale display. Each sub-field is divided into a reset period, an addressing period, and a sustaining discharge period.

For the respective reset periods, discharge conditions of all the display cells are equalized and become suitable for the addressing to be performed in a subsequent operation.

For the respective addressing periods, the relevant scanning pulses are sequentially applied to the Y electrode lines at the same time as display data signals are applied to the address electrode lines. Accordingly, when display data signals of a high level are applied while the scanning pulses are applied, surface charges are generated in the relevant discharge cells due to the addressing discharge, whereas surface charges are not generated in other discharge cells.

For the respective sustaining discharge period, the sustaining discharge pulses are alternately applied to all of the Y electrode and all of the X electrode lines, thereby causing a display discharge in the discharge cells in which the surface charges have been formed during the corresponding addressing periods. As a result, the brightness of the plasma display panel is proportional to the length of the sustaining discharge period occupying a unit frame. The length of the sustaining discharge period occupying the unit frame is 255T (T is a unit time). Therefore, including a case where the display discharge is not generated in the unit frame at all, the brightness can be displayed in 256 gray scales.

### SUMMARY OF THE INVENTION

The present invention provides a method and apparatus for driving a discharge display panel in such a way as to enhance linearity in the gray scale of a display image.

According to an aspect of the present invention, there is provided a method and apparatus for driving a discharge display panel in which a unit frame is driven in a time division manner with a plurality of sub-fields, the respective sub-fields having a reset period, an addressing period and a sustaining discharge period, and the number of sustaining discharge pulses being set for each sustaining discharge period. The method includes steps (a) thru (c) as follows. In step (a), the number of sustaining discharge pulses is set for each sustaining discharge period so as to be proportional to a gray-scale weight assigned to each sub-field and so as to be inversely proportional to an average signal level of each frame. In step (b), when a frame has an average signal level at which ratios between the gray-scale weights of the respective sub-fields are not varied in accordance with the set number of sustaining discharge pulses, the driving of the discharge display panel is performed in accordance with the set number of sustaining discharge pulses. In step (c), when the frame has an average signal level at which the ratios between the gray-scale weights of the respective sub-fields are varied in accordance with the set number of sustaining discharge pulses, a signal level of image data is adjusted, and the driving of the discharge display panel is performed in accordance with a gain inversely proportional to the average signal level regardless of the set number of sustaining discharge pulses.

According to the method and apparatus for driving a discharge display panel of the present invention, it is possible to perform automatic power control without varying the ratios between the gray-scale weights of the sub-fields. That is, it is possible to enhance the linearity in the gray scale of a display image while performing automatic power control.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view illustrating the internal structure of a three-electrode surface-discharge plasma display panel as a discharge display panel;

FIG. 2 is a cross-sectional view illustrating the structure of a unit cell in the plasma display panel shown in FIG. 1;

FIG. 3 is a timing diagram illustrating an address-display separation driving method for Y electrode lines of the plasma display panel shown in FIG. 1;

FIG. 4 is a graph illustrating an automatic power control method of a plasma display device;

FIG. 5 is a block diagram illustrating a plasma display device as a discharge display device for performing a driving method according to the present invention;

FIG. 6 is a block diagram illustrating the internal structure of a logic control unit in the plasma display device shown in FIG. 5;

FIG. 7A is a graph illustrating a characteristic of data NS relative to the number of sustaining discharge pulses output from a power controller shown in FIG. 6;

FIG. 7B is a graph illustrating a characteristic of gain data D_{G} output from the power controller shown in FIG. 6;

FIG. 8A is a diagram illustrating frame data input to a sub-field matrix section shown in FIG. 6;

FIG. 8B is a diagram illustrating frame data output from the sub-field matrix section shown in FIG. 6; and

FIG. 9 is a block diagram illustrating the internal structure of a matrix buffer section shown in FIG. 6.

### DETAILED DESCRIPTION OF THE INVENTION

Hereinafter, exemplary embodiments of the present invention will be described in detail with reference to the attached drawings.

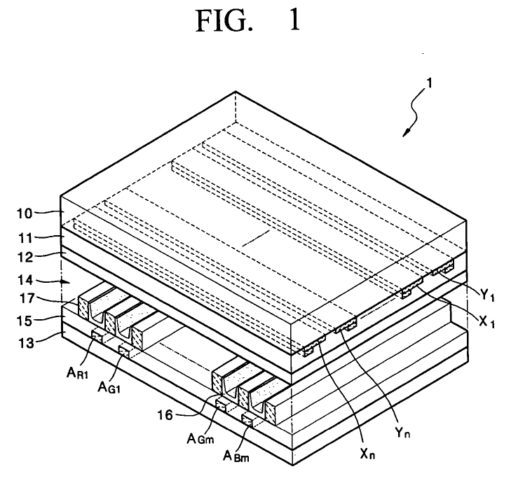

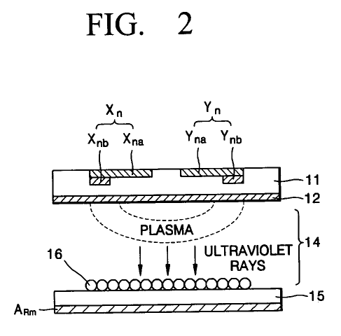

FIG. 1 is a perspective view illustrating the structure of a three-electrode surface-discharge plasma display panel as a discharge display panel, while FIG. 2 is a cross-sectional view illustrating the structure of a unit cell in the plasma display panel shown in FIG. 1.

As can be seen from FIGS. 1 and 2, between a front glass substrate 10 and a rear glass substrate 13 of the surface-discharge plasma display panel 1, address electrode lines A_{R1}, . . . , and A_{Bm}, dielectric layers 11 and 15, Y electrode lines Y₁, . . . , and Yₙ, X electrode lines X₁, . . . , and Xₙ, fluorescent substances 16, partitioning walls 17, and a magnesium monoxide (MgO) layer 12 are provided.

The address electrode lines A_{R1}, . . . , and A_{Bm} are formed in a predetermined pattern on the surface of the rear glass substrate 13. The rear dielectric layer 15 is formed on the whole surface including the address electrode lines A_{R1}, . . . , and A_{Bm}. The partitioning walls 17 are formed on the surface of the rear dielectric layer 15 so as to be parallel to the address electrode lines A_{R1}, . . . , and A_{Bm}. The partitioning walls 17 define discharge regions of the respective cells, and serve to prevent optical interference (cross talk) between the cells. The fluorescent substances 16 are formed between the partitioning walls 17.

The X electrode lines X₁, . . . , and Xₙ and the Y electrode lines Y₁, . . . , and Yₙ are formed in a predetermined pattern on the surface of the front glass substrate 10 so as to be perpendicular to the address electrode lines A_{R1}, . . . , and A_{Bm}. The respective intersections define the corresponding cells. Each of the X electrode lines X₁, . . . , and Xₙ and each of the Y electrode lines Y₁, . . . , and Yₙ are formed as a combination of a transparent electrode line (Xₙₐ, Yₙₐ in FIG. 2) made of a transparent conductive material, such as indium tin oxide (ITO), and a metal electrode line (X_{nb}, Y_{nb} in FIG. 2) for enhancing electrical conductivity thereof. The front dielectric layer 11 is formed on the whole surface including the X electrode lines X₁, . . . , and Xₙ and the Y electrode lines Y₁, . . . , and Yₙ. The protective layer 12, for example, a magnesium monoxide (MgO) layer, for protecting the panel 1 from an intensive electric field is formed on the whole surface of the front dielectric layer 11. Plasma forming gas is injected into the discharge spaces 14, and is then sealed up.

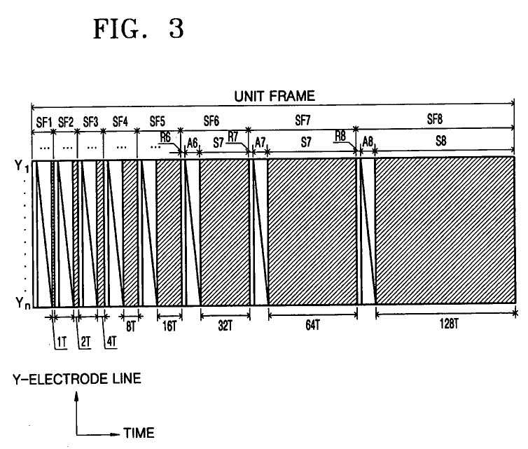

FIG. 3 is a timing diagram illustrating an address-display separation driving method for Y electrode lines of the plasma display panel shown in FIG. 1.

FIG. 3 shows an address-display separation driving method for the Y electrode lines Y₁, . . . , and Yₙ of the plasma display panel 1 of FIG. 1. As shown in FIG. 3, each unit frame is divided into eight sub-fields (SF1, . . . , SF8) so as to realize a time-divisional gray scale display. Each sub-field (SF1, . . . , SF8) is divided into a reset period R1, . . . , R8, an addressing period A1, . . . , A8, and a sustaining discharge period S1, . . . , S8.

For the respective reset periods R1, . . . , and R8, discharge conditions of all the display cells are equalized and become suitable for the addressing to be performed at the subsequent operation.

For the respective addressing periods A1, . . . , and A8, the relevant scanning pulses are sequentially applied to the Y electrode lines Y₁, . . . , and Yₙ at the same time as display data signals are applied to the address electrode lines A_{R1}, . . . , and A_{Bm} shown in FIG. 1. Accordingly, when display data signals of a high level are applied while the scanning pulses are applied, surface charges are generated in the relevant discharge cells due to the addressing discharge, whereas surface charges are not generated in other discharge cells.

For the respective sustaining discharge periods S1, . . . , and S8, the sustaining discharge pulses are alternately applied to all of the Y electrode lines Y₁, . . . , and Yₙ and to all of the X electrode lines X₁, . . . , and Xₙ, thereby causing the display discharge in the discharge cells in which the surface charges have been formed during the corresponding addressing periods A1, . . . , and A8. As a result, the brightness of the plasma display panel is proportional to the length of the sustaining discharge period S1, . . . , and S8 occupying a unit frame. The length of the sustaining discharge period S1, . . . , and S8 occupying the unit frame is 255T (T is a unit time). Therefore, including a case where the display discharge is not generated in the unit frame at all, the brightness can be displayed in 256 gray scales.

In the latter regard, the time 1T corresponding to 2⁰ is set for the sustaining discharge period S1 of the first sub-field SF1, the time 2T corresponding to 2¹ is set for the sustaining discharge period S2 of the second sub-field SF2, the time 4T corresponding to 2² is set for the sustaining discharge period S3 of the third sub-field SF3, the time 8T corresponding to 2³ is set for the sustaining discharge period S4 of the fourth sub-field SF4, the time 16T corresponding to 2⁴ is set for the sustaining discharge period S5 of the fifth sub-field SF5, the time 32T corresponding to 2⁵ is set for the sustaining discharge period S6 of the sixth sub-field SF6, the time 64T corresponding to 2⁶ is set for the sustaining discharge period S7 of the seventh sub-field SF7, and the time 128T corresponding to 2⁷ is set for the sustaining discharge period S8 of the eighth sub-field SF8.

Accordingly, by properly selecting the sub-fields to be displayed from the eight sub-fields, a total of 256 gray scales can be displayed, including the 0 (zero) gray scale in which the display discharge is not performed in any sub-field.

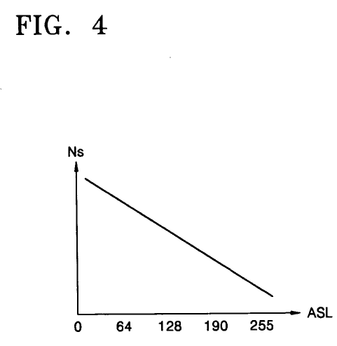

FIG. 4 is a graph illustrating an automatic power control method of a plasma display device.

Referring to FIG. 4, in an automatic power control method of the plasma display device, the number of sustaining discharge pulses determining the sustaining discharge periods S1 to S8 shown in FIG. 3 is set in a frame unit so as to be inversely proportional to an average signal level ASL of an image signal. For example, a look-up table such as Table 1 shown below is applied.

TABLE 1

| ASL | NS-SF1 | NS-SF2 | NS-SF3 | NS-SF4 | . . . |
|---|---|---|---|---|---|
| 0 | 4 | 8 | 16 | 32 | . . . |
| . | . | . | . | . | . . . |
| . | . | . | . | . | |
| . | . | . | . | . | |
| 32 | 3 | 7 | 14 | 28 | . . . |
| . | . | . | . | . | . . . |
| . | . | . | . | . | |
| . | . | . | . | . | |
| 64 | 3 | 6 | 12 | 24 | . . . |
| . | . | . | . | . | . . . |
| . | . | . | . | . | |
| . | . | . | . | . | |
| 90 | 2 | 5 | 10 | 20 | . . . |
| . | . | . | . | . | . . . |
| . | . | . | . | . | |
| . | . | . | . | . | |
| 128 | 2 | 4 | 8 | 16 | . . . |
| . | . | . | . | . | . . . |
| . | . | . | . | . | |
| . | . | . | . | . | |
| 160 | 2 | 3 | 6 | 12 | . . . |
| . | . | . | . | . | . . . |
| . | . | . | . | . | |
| . | . | . | . | . | |
| 190 | 1 | 2 | 4 | 8 | . . . |
| . | . | . | . | . | . . . |
| . | . | . | . | . | |
| . | . | . | . | . | |
| 255 | 1 | 1 | 2 | 4 | . . . |

Referring to Table 1, the ratios 1:2:4:8: . . . between the gray-scale weights of the sub-fields do not vary only when the average signal levels ASL of a unit frame are “0”, “64”, “128”, and “190”. In other words, at the remaining average signal levels, the ratios 1:2:4:8: . . . between the gray-scale weights of the sub-fields do vary. As a result, the advantage of the automatic power control is obtained, but there is a disadvantage in that linearity in the gray scale of the display images deteriorates.

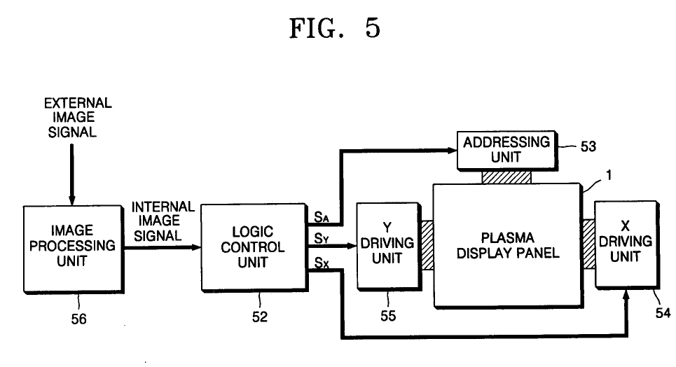

FIG. 5 is a block diagram illustrating a plasma display device as a discharge display device for performing a driving method according to the present invention. Referring to FIG. 5, the plasma display device comprises a plasma display panel 1 as a discharge display panel, an image processing unit 56, a logic control unit 52, an addressing unit 53, an X driving unit 54, and a Y driving unit 55. The plasma display panel 1 as the discharge display panel has the same structure as described with reference to FIG. 1. The image processing unit 56 converts external analog image signals into digital signals, and generates internal image signals such as red (R), green (G), and blue (B) image data of 8 bits, clock signals, vertical synchronization signals, and horizontal synchronization signals. The logic control unit 52 generates driving control signals S_{A}, S_{Y}, and S_{X} in accordance with the internal image signals from the image processing unit 56.

The addressing unit 53 processes the address signals S_{A} from the logic control unit 52, generates display data signals, and supplies the generated display data signals to the address electrode lines of the plasma display panel 1. The X driving unit 54 processes the X driving control signal S_{X} from the logic control unit 52, and supplies the processed X driving control signal S_{X} to the X electrode lines of the plasma display panel 1. The Y driving unit 55 processes the Y driving control signal S_{Y} from the logic control unit 52, and supplies the processed Y driving control signal S_{Y} to the Y electrode lines of the plasma display panel 1.

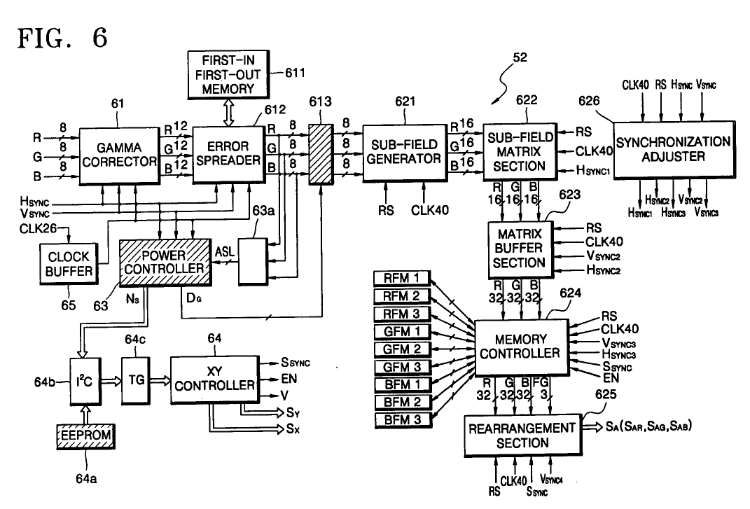

FIG. 6 is a block diagram illustrating the internal structure of the logic control unit in the plasma display device shown in FIG. 5.

Referring to FIG. 6, the logic control unit 52 shown in FIG. 5 comprises a clock buffer 65, a synchronization adjuster 626, a gamma corrector 61, an error spreader 612, a first-in first-out memory 611, a multiplier 613, a sub-field generator 621, a sub-field matrix section 622, a matrix buffer section 623, a memory controller 624, frame memories RFM1, . . . , BFM3, a rearrangement section 625, an average signal level detector 63a, a power controller 63, an EEPROM 64a, an I²C serial communication interface 64b, a timing signal generator 64c, and an XY controller 64.

The clock buffer 65 converts a clock signal CLK26 of 26 MHz from the image processing unit 56 (see FIG. 5) into a clock signal CLK40 of 40 MHz, and outputs the converted clock signal CLK40. The clock signal CLK40 of 40 MHz from the clock buffer 65, an initialization signal RS from an external circuit, and a horizontal synchronization signal H_{STNC} and a vertical synchronization signal V_{SYNC} from the image processing unit 56 (see FIG. 5) are inputted to the synchronization adjuster 626. The synchronization adjuster 626 outputs horizontal synchronization signals H_{SYNC1}, H_{SYNC2}, and H_{SYNC3} obtained by delaying the input horizontal synchronization signal H_{SYNC} by predetermined numbers of clocks, respectively, and also outputs vertical synchronization signals V_{SYNC2} and V_{SYNC3} obtained by delaying the input vertical synchronization signal V_{SYNC} by predetermined number of clocks, respectively.

The image data R, G, B input to the gamma corrector 61 have a reverse nonlinear input/output characteristic to protect a nonlinear input/output characteristic of a cathode ray tube. Therefore, the gamma corrector 61 processes the image data R, G, and B to correct or convert the reverse nonlinear input/output characteristic to a linear input/output characteristic. The error spreader 612 reduces a data transmission error by moving a position of the most significant bit as a boundary bit of the image data R, G, and B using the first-in first-out memory 611.

The multiplier 613 heightens or lowers the brightness level of the image data R, G, and B by multiplying the image data R, G, and B from the error spreader 612 by gain data D_{G} from the power controller 63. The details of the multiplier 613 together with the power controller 63 will be described.

The sub-field generator 621 converts the image data R, G, and B of 8 bits into image data R, G, and B having a number of bits corresponding to the number of sub-fields. For example, when driving a unit frame in gray scales with fourteen sub-fields, the sub-field generator 621 converts the image data R, G, and B of eight bits into image data R, G, and B of fourteen bits, adds null data “0” of a most significant bit and least significant bit thereto so as to reduce a data transmission error, and then outputs the image data R, G, and B of sixteen bits.

The sub-field matrix section 622 simultaneously receives data of different sub-fields, and rearranges the input image data R, G, and B of sixteen bits, thereby simultaneously outputting data of the same sub-field. The matrix buffer section 623 processes the image data R, G, and B of sixteen bits from the sub-field matrix section 622, and outputs image data R, G, and B of thirty two bits.

The memory controller 624 comprises a red memory controller for controlling three red (R) frame memories RFM1, RFM2, and RFM3, a green memory controller for controlling three green (G) frame memories GFM1, GFM2, and GFM3, and a blue memory controller for controlling three blue (B) frame memories BFM1, BFM2, and BFM3. The frame data from the memory controller 624 are continuously output in a frame unit and input to the rearrangement section 625. In FIG. 6, the reference symbol EN denotes an enable signal generated by the XY controller 64 and input to the memory controller 624 so as to control the data output of the memory controller 624. A reference symbol S_{SYNC} denotes a slot synchronization signal generated by the XY controller 64 and input to the memory controller 624 and the rearrangement section 625 so as to control the data input and output of the memory controller 624 and the rearrangement section 625 in a 32 bit slot unit. The rearrangement section 625 rearranges and outputs the image data R, G, and B of 32 bits from the memory controller 624 so as to correspond to the input format of the addressing unit 53 (see FIG. 5).

On the other hand, the average signal level detector 63a detects the average signal level ASL from the image data R, G, and B of 8 bits output from the error spreader 612 in a frame unit, and inputs the detected average signal level ASL to the power controller 63. The power controller 63 sets the number of sustaining discharge pulses for each sustaining discharge period so as to be proportional to a gray-scale weight assigned to each sub-field and to be inversely proportional to the average signal level ASL of each frame. In this case, when a frame has an average signal level ASL at which the ratios between the gray-scale weights of the respective sub-fields are not varied in accordance with the set number of sustaining discharge pulses, discharge-number data N_{S} corresponding to the set number of sustaining discharge pulses are output. In this case, the gain data D_{G} input to the multiplier 613 is “1”. That is, the image data R, G, and B from the error spreader 612 are input to the sub-field generator 621 without variation in the brightness level thereof.

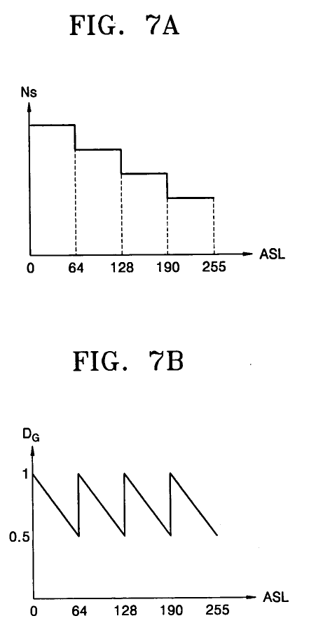

On the other hand, when the frame has an average signal level ASL at which the ratios between the gray-scale weights of the respective sub-fields are varied in accordance with the set number of sustaining discharge pulses, the gain data D_{G} inversely proportional to the average signal level ASL are output regardless of the set number of sustaining discharge pulses. In this case, the gain data D_{G} input to the multiplier 613 are smaller than “1” and greater than “0.5”. That is, the brightness level of the image data R, G, and B from the error spreader 612 is reduced so as to be inversely proportional to the average signal level ASL. In this case, when the frame has an average signal level ASL lower than the current average signal level ASL, the discharge-number data NS at the average signal level ASL at which the ratios between the gray-scale weights of the respective sub-fields are not varied in accordance with the set number of sustaining discharge pulses are output (see FIGS. 7A and 7B).

The timing control data corresponding to the driving sequences of the X electrode lines X₁, . . . , Xₙ and the Y electrode lines Y₁, . . . , Yₙ (see FIG. 1) are stored in the EEPROM 64a.

The discharge-number data NS from the power controller 63 and the timing control data from the EEPROM 64a are inputted to the timing signal generator 64c through the I²C serial communication interface 64b. The timing signal generator 64c generates timing signals in accordance with the discharge-number data and the timing control data. The XY controller 64 outputs the X driving control signal S_{X} and the Y driving control signal S_{Y} in accordance with the timing signals from the timing signal generator 64c.

FIG. 7A shows a characteristic of the data NS relative to the number of sustaining discharge pulses output from the power controller 63 of FIG. 6, while FIG. 7B shows a characteristic of the gain data D_{G} output from the power controller of FIG. 6. The data of FIGS. 7A and 7B are shown in Table 2.

TABLE 2

| ASL | NS-SF1 | NS-SF2 | NS-SF3 | NS-SF4 | . . . | DG |
|---|---|---|---|---|---|---|
| 0 | 4 | 8 | 16 | 32 | . . . | 1 |
| . | . | . | . | . | . . . | . |
| . | . | . | . | . | | . |
| . | . | . | . | . | | . |
| 32 | 4 | 8 | 16 | 32 | . . . | 0.75 |
| . | . | . | . | . | . . . | . |
| . | . | . | . | . | | . |
| . | . | . | . | . | | . |
| 63 | 4 | 8 | 16 | 32 | . . . | 0.5 |
| 64 | 3 | 6 | 12 | 24 | . . . | 1 |
| . | . | . | . | . | . . . | . |
| . | . | . | . | . | | . |
| . | . | . | . | . | | . |
| 90 | 3 | 6 | 12 | 24 | . . . | 0.75 |
| . | . | . | . | . | . . . | . |
| . | . | . | . | . | | . |
| . | . | . | . | . | | . |
| 127 | 3 | 6 | 12 | 24 | . . . | 0.5 |
| 128 | 2 | 4 | 8 | 16 | . . . | 1 |
| . | . | . | . | . | . . . | . |
| . | . | . | . | . | | . |
| . | . | . | . | . | | . |
| 160 | 2 | 4 | 8 | 16 | . . . | 0.75 |
| . | . | . | . | . | . . . | . |
| . | . | . | . | . | | . |
| . | . | . | . | . | | . |
| 189 | 2 | 4 | 8 | 16 | . . . | 0.5 |
| 190 | 1 | 2 | 4 | 8 | . . . | 1 |
| . | . | . | . | . | . . . | . |
| . | . | . | . | . | | . |
| . | . | . | . | . | | . |
| 255 | 1 | 2 | 4 | 8 | . . . | 0.5 |

Referring to FIGS. 6, 7A, and 7B, and Table 2, the power controller 63 sets the number of sustaining discharge pulses for each sustaining discharge period so as to be proportional to the gray-scale weight assigned to each sub-field and so as to be inversely proportional to the average signal level ASL of each frame. Here, when a frame has the average signal levels ASL=0, 64, 128, 190 at which the ratios between the gray-scale weights of the respective sub-fields are not varied in accordance with the set number of sustaining discharge pulses, the discharge-number data NS corresponding to the set number of sustaining discharge pulses are outputted. In this case, the gain data D_{G} input to the multiplier 613 is “1”. That is, the image data R, G, and B from the error spreader 612 are inputted to the sub-field generator 621 without variation in the brightness level thereof.

On the other hand, when the frame has the average signal levels ASL=1˜63, 65˜127, 129˜189, 191˜255 at which the ratios between the gray-scale weights of the respective sub-fields are varied in accordance with the set number of sustaining discharge pulses, the gain data D_{G} inversely proportional to the average signal level ASL are outputted regardless of the set number of sustaining discharge pulses. In this case, the gain data D_{G} input to the multiplier 613 are smaller than “1” and greater than “0.5”. That is, the brightness level of the image data R, G, and B from the error spreader 612 is reduced so as to be inversely proportional to the average signal level ASL. In this case, when the frame has the average signal levels ASL lower than the current average signal level ASL, the discharge-number data NS at the average signal level ASL at which the ratios between the gray-scale weights of the respective sub-fields are not varied in accordance with the set number of sustaining discharge pulses are outputted.

According to the automatic power control method described above, it is possible to perform automatic power control without varying the ratios between the gray-scale weights of the sub-fields. That is, it is possible to enhance the linearity in the gray scale of a display image while performing automatic power control.

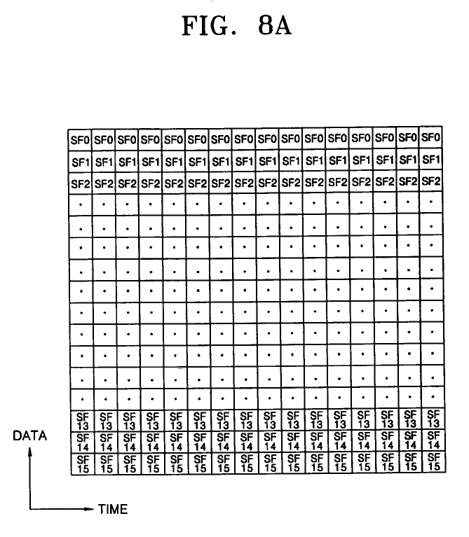

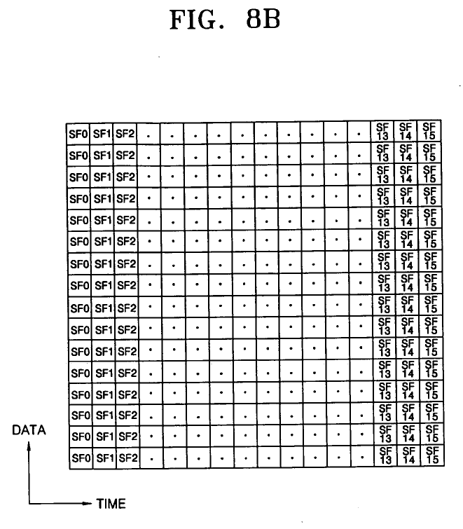

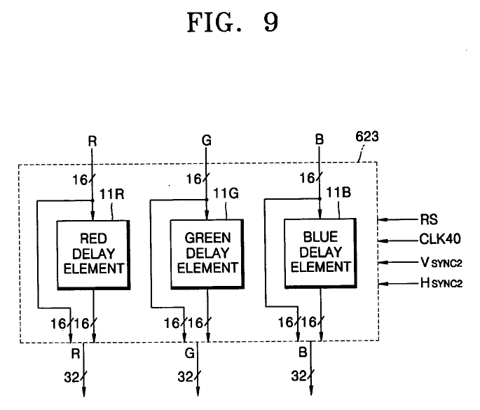

FIG. 8A is a diagram illustrating the frame data input to the sub-field matrix section 622 of the logic control unit 52 shown in FIG. 6.

Referring to FIG. 8A, the image data R, G, and B of 16 bits inputted to the sub-field matrix section 622 have a structure such that data of different sub-fields are simultaneously inputted.

FIG. 8B is a diagram illustrating the frame data output from the sub-field matrix section 622 of the logic control unit 52 shown in FIG. 6.

Referring to FIG. 8B, the image data R, G, and B of 16 bits outputted from the sub-field matrix section 622 have a structure such that data of the same sub-field are simultaneously inputted.

FIG. 9 shows the internal structure of the matrix buffer section 623 of the logic control unit 52 shown in FIG. 6.

Referring to FIG. 9, the matrix buffer section 623 comprises a red delay element 11R, a green delay element 11G, and a blue delay element 11B. The red delay element 11R delays the red image data R of 16 bits inputted from the sub-field matrix section 622 (see FIG. 6) by an input time of 16 clock pulses, and then outputs the red image data to positions corresponding to the first to sixteenth bits. On the other hand, the red image data R of 16 bits input from the sub-field matrix section 622 are directly outputted to positions corresponding to the seventeenth to thirty-second bits. Accordingly, the red image data R of 16 bits from the sub-field matrix section 622 are outputted as red image data R of 32 bits. This operation is true of the green and blue image data G and B. The reset signal RS, the clock signal CLK40, the second vertical synchronization signal V_{SYNC2}, and the second horizontal synchronization signal H_{SYNC2} are similarly inputted to the respective delay elements 11R, 11G and 11B.

As described above, according to the method of driving a discharge display panel of the present invention, it is possible to perform automatic power control without varying the ratios between the gray-scale weights of the sub-fields. That is, it is possible to enhance the linearity in gray scale of a display image while performing automatic power control.

While the present invention has been particularly shown and described with reference to exemplary embodiments thereof, it will be understood by those skilled in the art that various changes in form and detail may be made therein without departing from the spirit and scope of the present invention as defined by the appended claims.

1. A method of driving a discharge display panel in which a unit frame is driven in a time division manner with a plurality of sub-fields, the respective sub-fields having a reset period, an addressing period and a sustaining discharge period, and the number of sustaining discharge pulses being set for each sustaining discharge period, the method comprising the steps of:
(a) setting the number of sustaining discharge pulses for each sustaining discharge period so as to be proportional to a gray-scale weight assigned to each sub-field and so as to be inversely proportional to an average signal level of each frame;
(b) when a frame has an average signal level at which ratios between the gray-scale weights of the respective sub-fields are not varied in accordance with the set number of sustaining discharge pulses, performing the driving in accordance with the set number of sustaining discharge pulses; and
(c) when the frame has an average signal level at which the ratios between the gray-scale weights of the respective sub-fields are varied in accordance with the set number of sustaining discharge pulses, adjusting a signal level of image data and performing the driving in accordance with again inversely proportional to the average signal level of the frame regardless of the set number of sustaining discharge pulses.

2. The method according to claim 1, wherein when the frame has the average signal level at which the signal level of the image data is adjusted in step (c), the driving is performed in accordance with the number of sustaining discharge pulses at the average signal level of step (b) at which ratios between the gray-scale weights of the respective sub-fields are not varied in accordance with the set number of sustaining discharge pulses, among average signal levels lower than the average signal level.

3. An apparatus for driving a discharge display panel in which a unit frame is driven in a time division manner with a plurality of sub-fields, the respective sub-fields having a reset period, an addressing period and a sustaining discharge period, and the number of sustaining discharge pulses being set for each sustaining discharge period, said apparatus comprising:
setting means for setting the number of sustaining discharge pulses for each sustaining discharge period so as to be proportional to a gray-scale weight assigned to each sub-field and so as to be inversely proportional to an average signal level of each frame;
driving means for driving the discharge display panel in accordance with the set number of sustaining discharge pulses when a frame has an average signal level at which ratios between the gray-scale weights of the respective sub-fields are not varied in accordance with the set number of sustaining discharge pulses; and
adjusting means for adjusting a signal level of image data when the frame has an average signal level at which the ratios between the gray-scale weights of the respective sub-fields are varied in accordance with the set number of sustaining discharge pulses, said driving means driving the discharge display panel in accordance with a gain inversely proportional to the average signal level of the frame regardless of the set number of sustaining discharge pulses.

4. The apparatus of claim 1, wherein when the frame has the average signal level at which the signal level of image data is adjusted by said adjusting means, said driving means drives the discharge display panel in accordance with the number of sustaining discharge pulses at the average signal level, at which ratios between the gray-scale weights of the respective sub-fields are not varied in accordance with the set number of sustaining discharge pulses, among average signal levels lower than the average signal level.
